(19) United States
(12) Patent Application Publication
(10) Pub. No.: US 2026/0369989 A1
(43) Pub. Date: Nov. 19, 2026

(54) INPUT PROTECTION DEVICE

(71) Applicant: FANUC CORPORATION, Minamitsuru-gun, Yamanashi (JP)

(72) Inventor: Kazuya GOTO, Minamitsuru-gun, Yamanashi-ken (JP)

(73) Assignee: FANUC CORPORATION, Minamitsuru-gun, Yamanashi (JP)

(21) Appl. No.: 19/121,946

(22) PCT Filed: Oct. 26, 2022
(86) PCT No.: PCT/JP2022/039906

§ 371 Date: Apr. 17, 2025

(51) Int. Cl. H02H 9/00; H02H 3/00; H02H 3/24; H02H 9/02

(52) U.S. Cl. CPC H02H 9/001; H02H 3/006; H02H 3/243; H02H 9/025

(57) ABSTRACT

An input protection device includes a switch unit that is interposed between a power source and a load and that can switch connection and disconnection of the power source and the load; a switch control unit that controls the switch unit in response to a start signal and connects the power source and the load to each other; a low voltage protection unit that, when an input voltage from the power source is equal to or lower than a prescribed voltage threshold value, controls the switch unit and disconnects the power source and the load; a current limitation unit that limits a current supplied to the load to equal to or less than a limitation value; and a limitation-value change unit that, causes the limitation value to increase with the elapse of time such that the input voltage does not become equal to or lower than the voltage threshold value.

### TECHNICAL FIELD

The present disclosure relates to an input protection device.

### BACKGROUND ART

JP H09-056058 A discloses a device for preventing an inrush current from flowing from a power supply to a load when the power supply is turned on.

### SUMMARY OF THE INVENTION

It is desirable to provide a better input protection device.

An aspect of the present disclosure is characterized by an input protection device that limits a current supplied from a power supply to a load when the power supply is turned on, the input protection device including: a switch unit that is interposed between the power supply and the load and is configured to switch between connection and disconnection between the power supply and the load; a switch control unit configured to control the switch unit in response to an activation signal supplied from outside to connect the power supply and the load; a low voltage protection unit configured to control the switch unit to disconnect the power supply and the load, in a case where an input voltage from the power supply is equal to or lower than a predetermined voltage threshold; a current limiting unit configured to limit the current supplied to the load to a limit value or less; and a limit value changing unit configured to increase the limit value with time in a manner so that the input voltage does not become equal to or less than the voltage threshold, after the activation signal has been received.

### BRIEF DESCRIPTION OF DRAWINGS

FIG. 1 is a block diagram of an electric device;

FIG. 2 is a circuit diagram of an input protection device according to a first embodiment;

FIG. 3 FIGS. 3A, 3B, 3C, 3D and 3E are time charts showing a temporal change in each value of a reference example;

FIG. 4 FIGS. 4A, 4B, 4C, 4D, 4E, 4F, 4G and 4H are time charts showing a temporal change in each value of the input protection device according to the first embodiment;

FIG. 5 is a circuit diagram of an input protection device according to a second embodiment; and

FIG. 6 FIGS. 6A, 6B, 6C, 6D, 6E, 6F, 6G and 6H are time charts showing a temporal change in each value of the input protection device according to the second embodiment.

### DETAILED DESCRIPTION OF THE INVENTION

### 1. Electric Device 10

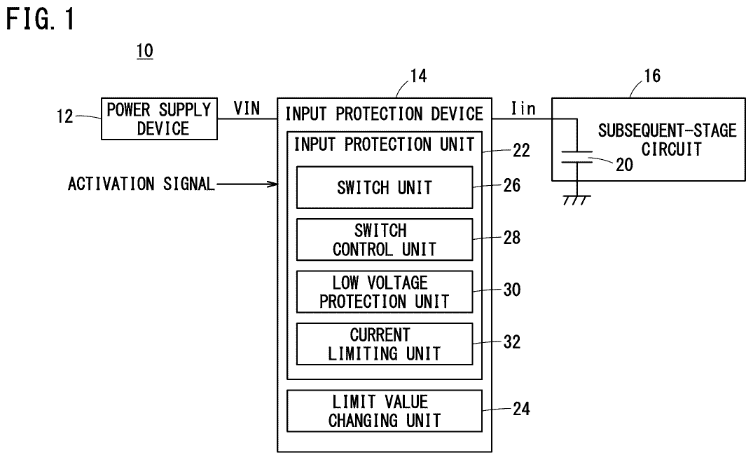

FIG. 1 is a block diagram of an electric device 10. The electric device 10 (including an electronic device) includes a power supply device 12, an input protection device 14, and a subsequent-stage circuit (load) 16. The input protection device 14 and the subsequent-stage circuit 16 are formed on, for example, a single printed circuit board. The subsequent-stage circuit 16 operates by power supplied by the power supply device 12. The subsequent-stage circuit 16 includes a capacitor 20 (electrolytic capacitor or the like) having a large capacitance. The input protection device 14 is interposed between the power supply device 12 and the subsequent-stage circuit 16.

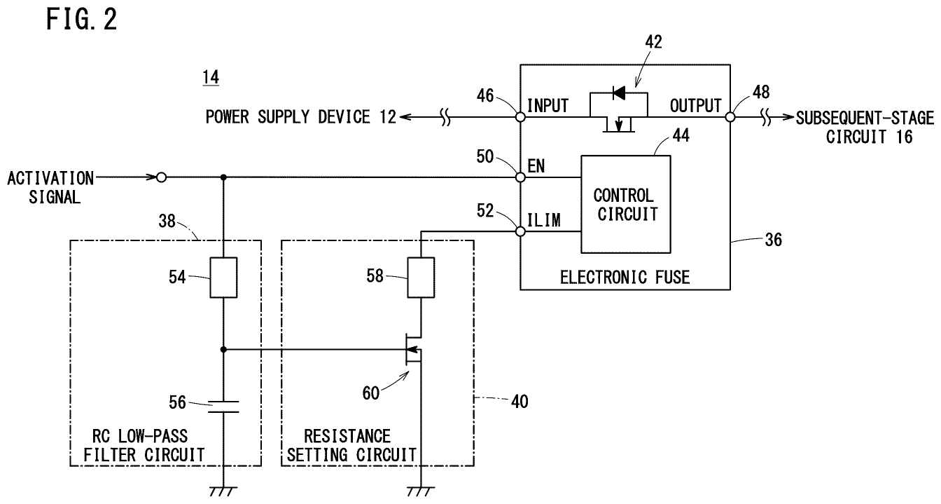

The terms used in the present specification are defined as follows:
Input Voltage VIN: the value of a voltage supplied from the power supply device 12 to the input protection device 14;
Back Electromotive Force ΔVIN_R: the value of a back electromotive force generated by a resistance of a cable connecting the power supply device 12 and the input protection device 14;
Back Electromotive Force ΔVIN_L: the value of a back electromotive force generated by an inductance of the cable connecting the power supply device 12 and the input protection device 14;
Current Iin: the value of a current supplied from the input protection device 14 to the subsequent-stage circuit 16;
Current Limit Value ILIM′: a limit value (variable value) of the current Iin set in the input protection device 14;
Current Limit Value ILIM: the upper limit of the current limit value ILIM′;
Charging Voltage VIN_INT: the value of a voltage of the capacitor 20 of the subsequent-stage circuit 16;
Variable Resistance Rset′: the value of a resistance (variable value) of a resistance setting circuit 40 (FIG. 2); and
Set Resistance Rset: the lower limit of the variable resistance Rset'.

### 2. Configuration of Input Protection Device 14

The input protection device 14 protects the subsequent-stage circuit 16 by disconnecting the power supply device 12 from the subsequent-stage circuit 16 when there is an abnormality in the power supplied from the power supply device 12 to the subsequent-stage circuit 16. The input protection device 14 includes an input protection unit 22 and a limit value changing unit 24.

The input protection unit 22 includes a switch unit 26, a switch control unit 28, a low voltage protection unit 30, and a current limiting unit 32. The switch unit 26 is interposed between the power supply device 12 and the subsequent-stage circuit 16, and switches between connection and disconnection between the power supply device 12 and the subsequent-stage circuit 16. The switch control unit 28 controls the switch unit 26 in response to an activation signal supplied from the outside to thereby connect the power supply device 12 and the subsequent-stage circuit 16. The low voltage protection unit 30 controls the switch unit 26 to disconnect the power supply device 12 from the subsequent-stage circuit 16 when the input voltage VIN by the power supply device 12 is equal to or lower than a predetermined voltage threshold Vth. That is, the low voltage protection unit 30 has a low voltage protection function. The current limiting unit 32 limits the current Iin supplied to the subsequent-stage circuit 16 to the current limit value ILIM′ or less. That is, the current limiting unit 32 has an inrush current suppression function.

The limit value changing unit 24 increases the current limit value ILIM′ used by the current limiting unit 32 with the passage of time in a manner so that the input voltage VIN by the power supply device 12 does not become equal to or less than the predetermined voltage threshold Vth after the activation signal supplied from the outside has been received. The limit value changing unit 24 increases the current limit value ILIM′ with the passage of time, thereby suppressing a rapid increase in the current Iin supplied from the input protection device 14 to the subsequent-stage circuit 16.

### 3. Specific Example of Input Protection Device 14

### 3-1. First Embodiment

### Configuration

FIG. 2 is a circuit diagram of the input protection device 14 according to a first embodiment. The input protection device 14 includes an electronic fuse 36, an RC (resistance-capacitance) low-pass filter circuit 38, and a resistance setting circuit 40. The electronic fuse 36 corresponds to the input protection unit 22 shown in FIG. 1. The RC low-pass filter circuit 38 and the resistance setting circuit 40 correspond to the limit value changing unit 24 shown in FIG. 1.

The electronic fuse 36 is also referred to as an eFUSE. The electronic fuse 36 is an integrated circuit having a switch element 42 and a control circuit 44. The switch element 42 is, for example, a MOSFET (metal-oxide semiconductor field-effect transistor). The switch element 42 corresponds to the switch unit 26 shown in FIG. 1. The control circuit 44 includes an electronic circuit for realizing the functions of the switch control unit 28, the low voltage protection unit 30, the current limiting unit 32, and the like shown in FIG. 1. That is, the control circuit 44 sets the voltage threshold Vth to a constant value. The control circuit 44 turns off the switch element 42 when the input voltage VIN falls below the voltage threshold Vth. The control circuit 44 limits the current Iin to the current limit value ILIM′. The control circuit 44 changes the current limit value ILIM′ according to the variable resistance Rset′.

The electronic fuse 36 includes an input terminal 46 (INPUT), an output terminal 48 (OUTPUT), an EN terminal (enable terminal) 50, and an ILIM terminal 52. The input terminal 46 and the output terminal 48 are connected to each other via the switch element 42. Each of the EN terminal 50 and the ILIM terminal 52 is connected to the control circuit 44. The input terminal 46 is connected to the power supply device 12. The output terminal 48 is connected to the subsequent-stage circuit 16. The EN terminal 50 is connected to a device (not shown) that outputs the activation signal. The ILIM terminal 52 is connected to the resistance setting circuit 40. Although not shown, a voltage monitoring device formed on a single printed circuit board together with the electronic fuse 36, other electric devices, and the like are given as devices that output the activation signal. The voltage monitoring device and other electric devices output the activation signal when the input voltage VIN exceeds a predetermined voltage.

The RC low-pass filter circuit 38 includes a resistor 54 and a capacitor 56. A first terminal of the resistor 54 is connected to the EN terminal 50 provided in the electronic fuse 36 and to a device (not shown) that outputs the activation signal. A second terminal of the resistor 54 is connected to a first terminal of the capacitor 56 and to a gate terminal of a FET (field-effect transistor) 60 provided in the resistance setting circuit 40. A second terminal of the capacitor 56 is connected to ground. The RC low-pass filter circuit 38 gradually increases the voltage of the activation signal supplied from the outside and supplies, as a gate signal, the voltage to the gate terminal of the FET 60 provided in the resistance setting circuit 40.

The resistance setting circuit 40 has a series circuit in which a fixed resistor 58 and the FET 60 are connected in series. The resistance value of the fixed resistor 58 is constant. A first terminal of the fixed resistor 58 is connected to the ILIM terminal 52 of the electronic fuse 36. A second terminal of the fixed resistor 58 is connected to the drain terminal of the FET 60. The FET 60 is, for example, a MOSFET.

The drain terminal of the FET 60 is connected to the second terminal of the fixed resistor 58. The source terminal of the FET 60 is connected to ground. The gate terminal of the FET 60 is connected to the output terminal of the RC low-pass filter circuit 38 (the second terminal of the resistor 54 and the first terminal of the capacitor 56).

As described above, the RC low-pass filter circuit 38 gradually increases the voltage supplied to the gate terminal of the FET 60. As a result, the resistance value between the drain and the source of the FET 60 gradually decreases. As a result, the variable resistance Rset′ of the resistance setting circuit 40 gradually lowers. The variable resistance Rset′ is the resistance value (variable value) of the resistance setting circuit 40 as described above. The control circuit 44 is configured to set the current limit value ILIM′ according to the variable resistance Rset′. Therefore, the control circuit 44 increases the current limit value ILIM′ in accordance with the decrease in the variable resistance Rset′. As described above, the current limit value ILIM′ is a limit value (variable value) of the current Iin set in the input protection device 14. When the current limit value ILIM′ gradually increases, the current Iin also gradually increases. As described above, the current Iin is a value of the current supplied from the input protection device 14 to the subsequent-stage circuit 16. As described above, since the RC low-pass filter circuit 38 and the resistance setting circuit 40 are provided, the current Iin can be gradually increased.

### Comparison Between First Embodiment and Reference Example

The input protection device 14 is characterized in that it is provided with a variable resistance Rset′. Here, the operation of the input protection device 14 in the case where no variable resistance Rset′ is provided and the operation of the input protection device 14 in the case where the variable resistance Rset′ is provided will be compared.

### Operation of Reference Example

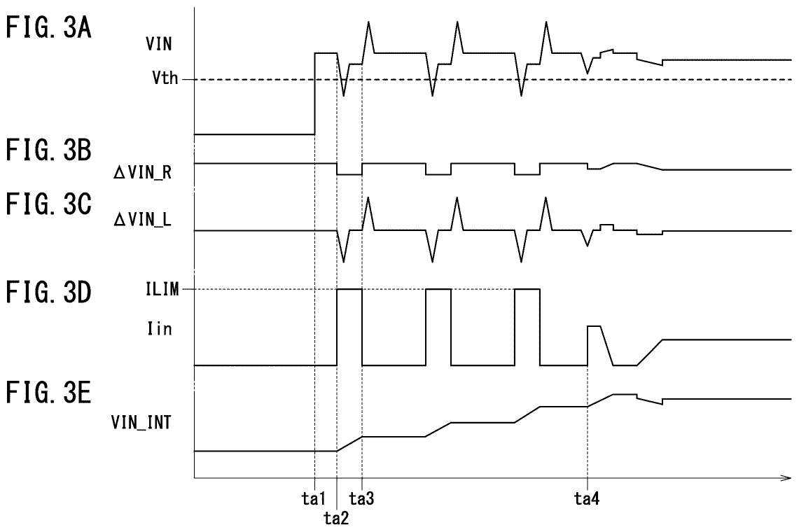

The input protection device 14 in the case where no variable resistance Rset′ is not provided is used as a reference example. Each of FIG. 3A to JE is a time chart showing a temporal change in each value of the input protection device 14 according to the reference example. FIG. 3A is a time chart of the input voltage VIN. FIG. 3B is a time chart of the back electromotive force ΔVIN_R. FIG. 3C is a time chart of the back electromotive force ΔVIN_L. FIG. 3D is a time chart of the current Iin. FIG. 3E is a time chart of the charging voltage VIN_INT. Note that, for ease of description, FIGS. 3A to 3E are illustrated in an exaggerated manner.

At a time ta1 when the power supply is turned on, the input voltage VIN rises. Thereafter, at a time ta2, the current Iin rapidly increases to the current limit value ILIM. With the rapid increase in the current Iin, a large back electromotive force ΔVIN_R is generated by the resistance of the cable between the power supply device 12 and the input protection device 14. Further, with the rapid increase in the current Iin, a large back electromotive force ΔVIN_L is generated by the inductance of the cable between the power supply device 12 and the input protection device 14. The input voltage VIN is greatly reduced by the back electromotive forces ΔVIN_R and ΔVIN_L. When the input voltage VIN falls below the voltage threshold Vth, the control circuit 44 (the low voltage protection unit 30) switches the switch element 42 from ON to OFF to disconnect the power supply device 12 and the subsequent-stage circuit 16.

At a time ta3 when the switch element 42 is switched, the current Iin rapidly decreases. With the rapid decrease in the current Iin, the back electromotive force ΔVIN_L is generated in the direction opposite to the back electromotive forces ΔVIN_R and ΔVIN_L generated at the time ta2. The input voltage VIN is greatly increased by the back electromotive force ΔVIN_L thus generated in the opposite direction. At the time when the back electromotive forces ΔVIN_R and ΔVIN_L are not generated, the input voltage VIN is equal to the input voltage VIN at the time tal. Such a behavior repeatedly occurs.

The capacitor 20 of the subsequent-stage circuit 16 is charged while the current Iin is supplied from the input protection device 14 to the subsequent-stage circuit 16. That is, as shown in FIG. 3E, the charging voltage VIN_INT increases only while the current Iin is supplied from the input protection device 14 to the subsequent-stage circuit 16.

At a time ta4, the charging voltage VIN_INT becomes substantially equal to the input voltage VIN. Then, the current Iin decreases, and the back electromotive forces ΔVIN_R and ΔVIN_L decrease. Since the back electromotive forces ΔVIN_R and ΔVIN_L are reduced, the fluctuation of the input voltage VIN is also reduced. As a result, the input voltage VIN does not fall below the voltage threshold Vth, and thus the activation of the charging voltage VIN_INT is completed. Thereafter, the current Iin increases with an increase in current consumption due to the start of the operation of the subsequent-stage circuit 16.

As described above, in the input protection device 14 according to the reference example, the peak of the input voltage VIN becomes excessively large. Therefore, there is a possibility that the components of the input protection device 14 may be damaged. In the input protection device 14 according to the reference example, the current Iin is intermittently supplied from the input protection device 14 to the subsequent-stage circuit 16. Therefore, it takes a long time to charge the capacitor 20 of the subsequent-stage circuit 16.

### Operation of Input Protection Device 14 According to First Embodiment

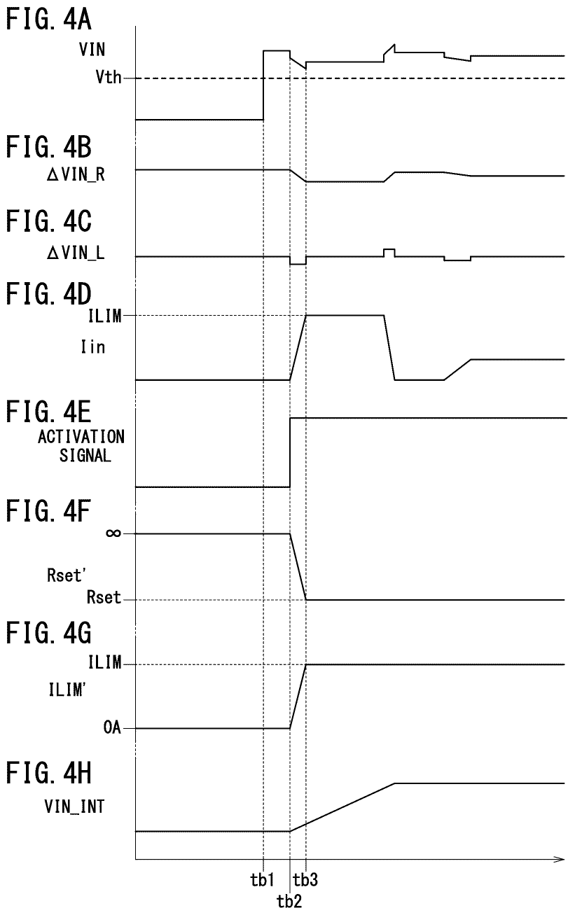

Each of FIGS. 4A to 4H is a time chart showing a temporal change in each value of the input protection device 14 according to the first embodiment. FIG. 4A is a time chart of the input voltage VIN. FIG. 4B is a time chart of the back electromotive force ΔVIN_R. FIG. 4C is a time chart of the back electromotive force ΔVIN_L. FIG. 4D is a time chart of the current Iin. FIG. 4E is a time chart of the activation signal. FIG. 4F is a time chart of the variable resistance Rset′. FIG. 4G is a time chart of the current limit value ILIM′. FIG. 4H is a time chart of the charging voltage VIN_INT. Note that, as in FIGS. 3A to 3E, FIGS. 4A to 4H are illustrated in an exaggerated manner.

At a time tb1 when the power supply is turned on, the input voltage VIN rises. Further, after the rise of the input voltage VIN, the activation signal is supplied at the time tb2. Then, the output voltage of the RC low-pass filter circuit 38 starts to increase from zero (not shown). As time elapses, the output voltage of the RC low-pass filter circuit 38 gradually increases. The degree of increase in the output voltage of the RC low-pass filter circuit 38 is determined by the time constant (RC). The output voltage from the RC low-pass filter circuit 38 is supplied to the gate terminal of the FET 60. As a result, the resistance value between the drain and the source of the FET 60 starts to decrease from infinity. As time passes, the resistance value between the drain and the source of the FET 60 gradually decreases. Therefore, as shown in FIG. 4F, the variable resistance Rset′ starts to decrease. As time elapses, the variable resistance Rset′ gradually decreases. Then, as shown in FIG. 4G, the current limit value ILIM′ starts to increase. The current limit value ILIM′ gradually increases with the passage of time. As shown in FIG. 4D, the current Iin gradually increases in accordance with the increase in the current limit value ILIM′. Since the current limit value ILIM′ gradually increases, the current Iin does not increase rapidly. Therefore, as shown in FIGS. 4B and 4C, the magnitudes of the back electromotive forces ΔVIN_R and ΔVIN_L are smaller than the magnitudes of the back electromotive forces ΔVIN_R and ΔVIN_L shown in FIG. 3C. Therefore, the decrease in the input voltage VIN is small accordingly. As a result, the input voltage VIN does not fall below the voltage threshold Vth.

At the time tb3, the resistance value between the drain and the source of the FET 60 becomes substantially zero. As shown in FIG. 4F, the variable resistance Rset′ becomes equal to the set resistance Rset which is the lower limit. As shown in FIG. 4G, the current limit value ILIM′ becomes the current limit value ILIM which is the upper limit. As shown in FIG. 4D, the current Iin also becomes equal to the current limit value ILIM. When the current Iin no longer changes, the back electromotive forces ΔVIN_R and ΔVIN_L are accordingly no longer generated, and the input voltage VIN stops changing.

In the first embodiment, the current Iin does not increase rapidly between the time tb1 and the time tb3. Therefore, the change in the input voltage VIN due to the back electromotive force ΔVIN_R and the back electromotive force ΔVIN_L becomes small, and thus the input voltage VIN does not fall below the voltage threshold Vth. Therefore, according to the first embodiment, the input voltage VIN can be prevented from becoming excessively large, and as a result, there is no possibility that the components of the input protection device 14 are damaged.

In the first embodiment, the input voltage VIN does not fall below the voltage threshold Vth, and thus the control circuit 44 (the low voltage protection unit 30) maintains the connection state of the switch element 42. That is, the connection state between the power supply device 12 and the subsequent-stage circuit 16 is maintained until the capacitor 20 of the subsequent-stage circuit 16 is charged. Therefore, according to the first embodiment, the capacitor 20 of the subsequent-stage circuit 16 can be charged quickly.

### 3-2. Second Embodiment

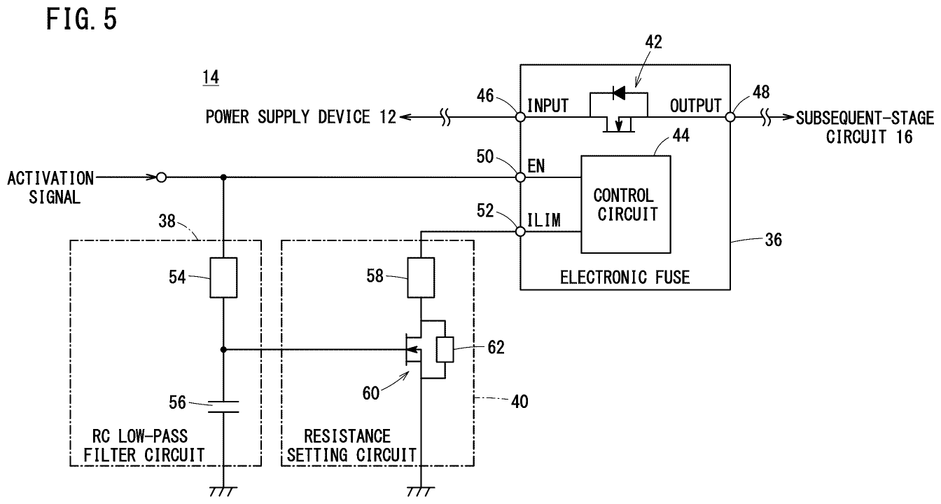

FIG. 5 is a circuit diagram of the input protection device 14 according to a second embodiment. The second embodiment is an improvement of the first embodiment. The basic configuration of the input protection device 14 according to the second embodiment is the same as the configuration of the input protection device 14 according to the first embodiment.

In the first embodiment, the variable resistance Rset′ starts to decrease from infinity. In this case, the current limiting unit 32 may not be able to accurately set the current limit value ILIM due to noise or the like. In the second embodiment, the resistance setting circuit 40 includes a noise prevention resistor 62 that bypasses the FET 60. A first terminal of the noise prevention resistor 62 is connected to the source terminal of the FET 60. A first terminal of the noise prevention resistor 62 is connected to the drain terminal of the FET 60. The resistance value Rset2 of the noise prevention resistor 62 is larger than the resistance value Rset1 of the fixed resistor 58.

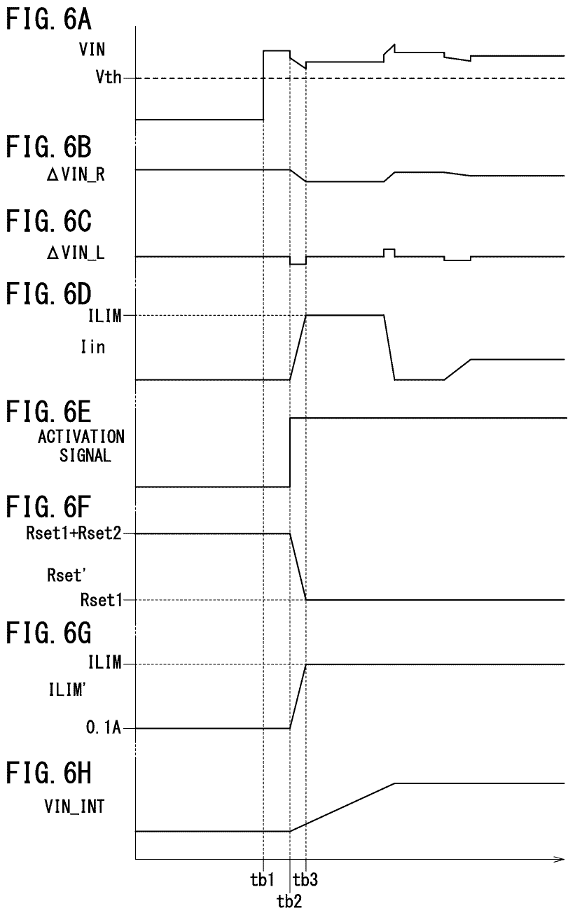

Each of FIGS. 6A to 6H is a time chart showing a temporal change of each value of the input protection device 14 according to the second embodiment. FIGS. 6A to 6E and 6H are the same as the drawings 4A to 4E and 4H. FIG. 6F is a time chart of the variable resistance Rset′. FIG. 6G is a time chart of the current limit value ILIM′.

As shown in FIG. 6F, the upper limit of the variable resistance Rset′ is the sum of the resistance value Rset1 and the resistance value Rset2. Since the FET 60 is bypassed by the noise prevention resistor 62, the variable resistance Rset′ does not become excessively large. Therefore, the current limiting unit 32 can accurately set the current limit value ILIM without being affected by noise.

### 3-3. Other Embodiments

In the above embodiment, the case where the activation signal supplied from the outside is supplied as the gate signal to the gate terminal of the FET 60 provided in the resistance setting circuit 40 via the RC low-pass filter circuit 38 has been described as an example, but the present invention is not limited thereto. The gate signal output by another output circuit (for example, a processor or the like) may be supplied to the gate terminal of the FET 60. In this case, the other output circuit gradually increase the magnitude of the gate signal.

### 4. Supplementary Notes

The following Supplementary Notes are further disclosed in relation to the above embodiments and modifications.

### Supplementary Note 1

The input protection device (14) that limits a current (Iin) supplied from the power supply (12) to the load (16) when the power supply is turned on, includes: the switch unit (26) that is interposed between the power supply and the load and is configured to switch between connection and disconnection between the power supply and the load; the switch control unit (28) configured to control the switch unit in response to an activation signal supplied from outside to connect the power supply and the load; the low voltage protection unit (30) configured to control the switch unit to disconnect the power supply and the load, in the case where the input voltage (VIN) from the power supply is equal to or lower than a predetermined voltage threshold; the current limiting unit (32) configured to limit the current supplied to the load to the limit value (ILIM′) or less; and the limit value changing unit (24) configured to increase the limit value with time in a manner so that the input voltage does not become equal to or less than the voltage threshold, after the activation signal has been received.

### Supplementary Note 2

In the input protection device according to Supplementary Note 1, the switch unit, the switch control unit, the low voltage protection unit, and the current limiting unit may be included in the single integrated circuit (36).

### Supplementary Note 3

In the input protection device according to Supplementary Note 2, the limit value changing unit may include the resistance setting circuit (40) connected to the integrated circuit, the resistance setting circuit having the resistance value (Rset′) that is able to be lowered to the lower limit (Rset) set in advance, and the limit value may change in accordance with the resistance value of the resistance setting circuit.

### Supplementary Note 4

In the input protection device according to Supplementary Note 3, the resistance setting circuit may include the series circuit in which the fixed resistor (58) having a constant resistance value and the FET (field-effect transistor) (60) are connected in series, and the limit value changing unit may include the output circuit that outputs the gate signal for changing the resistance value of the resistance setting circuit, to the field-effect transistor.

### Supplementary Note 5

In the input protection device according to Supplementary Note 4, the output circuit may further include the RC (resistance-capacitance) low-pass filter circuit (38) that changes the resistance value of the resistance setting circuit by using the activation signal.

### Supplementary Note 6

In the input protection device according to Supplementary Note 4 or 5, the limit value changing unit may include the noise prevention resistor (62) that is connected to the source terminal of the FET and the drain terminal of the FET and has a resistance value larger than the resistance value of the fixed

Although the present disclosure has been described in detail, the present disclosure is not limited to the above-described individual embodiments. In these embodiments, various addition, replacement, modification, partial deletion, and the like can be made without departing from the essence and gist of the present disclosure or without departing from the essence and gist of the present disclosure derived from the contents described in the claims and equivalents thereof. These embodiments may also be implemented in combination. For example, in the above-described embodiments, the order of operations and the order of processes are shown as examples, and the present invention is not limited to these. The same applies to a case where numerical values or mathematical equations are used in the description of the above-described embodiments.

### REFERENCE SIGNS LIST

12: power supply device (power supply)
14: input protection device
16: subsequent-stage circuit (load)
24: limit value changing unit
26: switch unit
28: switch control unit
30: low voltage protection unit
32: current limiting unit
36: electronic fuse (integrated circuit)
38: RC low-pass filter circuit
40: resistance setting circuit
58: fixed resistor
60: FET
62: noise prevention resistor

1. An input protection device that limits a current supplied from a power supply to a load when the power supply is turned on, the input protection device comprising:
a switch unit that is interposed between the power supply and the load and is configured to switch between connection and disconnection between the power supply and the load;
a switch control unit configured to control the switch unit in response to an activation signal supplied from outside to connect the power supply and the load;
a low voltage protection unit configured to control the switch unit to disconnect the power supply and the load, in a case where an input voltage from the power supply is equal to or lower than a predetermined voltage threshold;
a current limiting unit configured to limit the current supplied to the load to a limit value or less; and
a limit value changing unit configured to increase the limit value with time in a manner so that the input voltage does not become equal to or less than the voltage threshold, after the activation signal has been received.

2. The input protection device according to claim 1, wherein
the switch unit, the switch control unit, the low voltage protection unit, and the current limiting unit are included in a single integrated circuit.

3. The input protection device according to claim 2, wherein
the limit value changing unit includes a resistance setting circuit that is connected to the integrated circuit, the resistance setting circuit having a resistance value that is configured to be lowered to a lower limit set in advance, and
the limit value changes according to the resistance value of the resistance setting circuit.

4. The input protection device according to claim 3, wherein
the resistance setting circuit includes a series circuit in which a fixed resistor having a constant resistance value and a field-effect transistor are connected in series, and
the limit value changing unit includes an output circuit configured to output a gate signal for changing the resistance value of the resistance setting circuit, to the field-effect transistor.

5. The input protection device according to claim 4, wherein
the output circuit includes a resistance-capacitance low-pass filter circuit configured to change the resistance value of the resistance setting circuit by using the activation signal.

6. The input protection device according to claim 4, wherein
the limit value changing unit includes a noise prevention resistor that is connected to a source terminal of the field-effect transistor and a drain terminal of the field-effect transistor and has a resistance value larger than the resistance value of the fixed resistor.

7. The input protection device according to claim 5, wherein
the limit value changing unit includes a noise prevention resistor that is connected to a source terminal of the field-effect transistor and a drain terminal of the field-effect transistor and has a resistance value larger than the resistance value of the fixed resistor.
